(19) United States
(12) Patent Application Publication
(10) Pub. No.: US 2024/0334208 A1
(43) Pub. Date: Oct. 3, 2024

(54) METHOD AND APPARATUS FOR LIFE CYCLE MANAGEMENT OF AI/ML MODELS IN WIRELESS COMMUNICATION NETWORKS

(71) Applicant: Samsung Electronics Co., Ltd., Suwon-si (KR)

(72) Inventors: Ameha Tsegaye ABEBE, Suwon-si (KR); Seongmok LIM, Suwon-si (KR); Yeongeun LIM, Suwon-si (KR); Youngrok JANG, Suwon-si (KR); Hyoungju JI, Suwon-si (KR)

(21) Appl. No.: 18/620,270

(22) Filed: Mar. 28, 2024

(30) Foreign Application Priority Data
Mar. 31, 2023 (KR) 10-2023-0042806
Mar. 28, 2024 (KR) 10-2024-0042765

(51) Int. Cl. H04W 24/02; H04W 8/22; H04W 24/08

(52) U.S. Cl. CPC H04W 24/02; H04W 8/22; H04W 24/08

(57) ABSTRACT

The disclosure relates to a 5th generation (5G) or 6th generation (6G) communication system for supporting a higher data transmission rate. A method performed by a user equipment (UE) in a communication system is provided. The method includes transmitting, by the UE to a base station, capability information indicating a set of artificial intelligence (AI)/machine learning (ML) functionalities, receiving, by the UE from the base station, configuration information associated with an AI/ML inference, wherein the configuration information indicates at least one of a measurement configuration or a reporting configuration, receiving, by the UE from the base station, information to indicate activation of an AI/ML functionality, and performing, by the UE, an AI/ML based operation based on the configuration information.

### CROSS-REFERENCE TO RELATED APPLICATION(S)

This application is based on and claims priority under 35 U.S.C. § 119 (a) of a Korean patent application number 10-2023-0042806, filed on Mar. 31, 2023, in the Korean Intellectual Property Office, the disclosure of which is incorporated by reference herein in its entirety.

### BACKGROUND

### 1. Field

The disclosure relates to the field of 5th generation (5G) and beyond 5G communication networks. More particularly, the disclosure relates to life cycle management (LCM) of artificial intelligence/machine learning (AI/ML) models in wireless communication networks.

### 2. Description of Related Art

5G mobile communication technologies define broad frequency bands such that high transmission rates and new services are possible, and can be implemented not only in “Sub 6 gigahertz (GHZ)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and apparatus for life cycle management of AI/ML models in wireless communication networks. For the AI/ML models which are fully or partly be deployed at the terminal, based on the various embodiments of this disclosure, the network may assist/control the life cycle management.

Another aspect of the disclosure is to provide methods and systems for a UE to reports its capability by including information pertaining to the AI/ML functionalities it supports.

Another aspect of the disclosure is to provide methods and systems for the gNodeB (gNB) to receive AI/ML related capability reports from the UE and to configure the UE with AI/ML operations accordingly.

Another aspect of the disclosure is to provide methods and systems for a UE to report it capability by including information pertaining to the AI/ML models it supports and their functions.

Another aspect of the disclosure is to provide methods and systems for a gNB to receive UE's capability information related to the models the UE supports and configure the UE with AI/ML operations accordingly.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes transmitting, to a base station, capability information indicating a set of artificial intelligence (AI)/machine learning (ML) functionalities, receiving, from the base station, configuration information associated with an AI/ML inference, wherein the configuration information indicates at least one of a measurement configuration or a reporting configuration, receiving, from the base station, information to indicate activation of an AI/ML functionality, and performing an AI/ML based operation based on the configuration information.

In accordance with another aspect of the disclosure, a user equipment (UE) in a communication system is provided. The UE includes a transceiver, and at least one processor configured to transmit, to a base station, capability information indicating a set of artificial intelligence (AI)/machine learning (ML) functionalities, receive, from the base station, configuration information associated with an AI/ML inference, wherein the configuration information indicates at least one of a measurement configuration or a reporting configuration, receive, from the base station, information to indicate activation of an AI/ML functionality, and perform an AI/ML based operation based on the configuration information.

In accordance with another aspect of the disclosure, a method performed by a base station in a communication system is provided. The method includes receiving, from a user equipment (UE), capability information indicating a set of artificial intelligence (AI)/machine learning (ML) functionalities, transmitting, to the UE, configuration information associated with an AI/ML inference, wherein the configuration information indicates at least one of a measurement configuration or a reporting configuration, and transmitting, to the UE, information to indicate activation of an AI/ML functionality for an AI/ML based operation.

In accordance with another aspect of the disclosure, a base station in a communication system is provided. The base station includes a transceiver, and at least one processor configured to receive, from a user equipment (UE), capability information indicating a set of artificial intelligence (AI)/machine learning (ML) functionalities, transmit, to the UE, configuration information associated with an AI/ML inference, wherein the configuration information indicates at least one of a measurement configuration or a reporting configuration, and transmit, to the UE, information to indicate activation of an AI/ML functionality for an AI/ML based operation.

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include transmitting, by the UE to a base station, capability information indicating a set of artificial intelligence (AI)/machine learning (ML) functionalities, receiving, by the UE from the base station, configuration information associated with an AI/ML inference, wherein the configuration information indicates at least one of a measurement configuration or a reporting configuration, receiving, by the UE from the base station, information to indicate activation of an AI/ML functionality, and performing, by the UE, an AI/ML based operation based on the configuration information.

The disclosure provides methods and apparatus for life cycle management of AI/ML models in wireless communication networks. For the AI/ML models which are fully or partly be deployed at the terminal, based on the various embodiments of this disclosure, the network may assist/control the life cycle management.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIG. 2A illustrates an example wireless transmit path according to an embodiment of the disclosure;

FIG. 2B illustrates an example wireless receive path according to an embodiment of the disclosure;

FIG. 3A illustrates an example UE according to an embodiment of the disclosure;

FIG. 3B illustrates an example gNB according to an embodiment of the disclosure;

FIG. 4 illustrates a cross-polarized MIMO antenna system according to an embodiment of the disclosure;

FIG. 5 illustrates a layout for channel state information reference signal (CSI-RS) resource mapping in an orthogonal frequency division multiple access (OFDM) time-frequency grid according to an embodiment of the disclosure;

FIG. 6 illustrates an example of precoder construction in Type II channel state information (CSI) according to an embodiment of the disclosure;

FIG. 7 illustrates single-sided and two-sided models according to an embodiment of the disclosure;

FIG. 8 illustrates Model-identification (ID) based LCM according to an embodiment of the disclosure;

FIG. 9 illustrates functionality based LCM according to an embodiment of the disclosure;

FIG. 10 illustrates hierarchical representation of AI/ML features and functionalities according to an embodiment of the disclosure;

FIG. 11 illustrates possible definition of a functionality according to an embodiment of the disclosure;

FIG. 12 illustrates hierarchical representation of higher layer signaling for functionality-based LCM according to an embodiment of the disclosure;

FIG. 13 illustrates a procedure for functionality-based LCM according to an embodiment of the disclosure;

FIG. 14 illustrates a case for AI/ML functionality monitoring according to an embodiment of the disclosure;

FIG. 15 illustrates relationship between data collection and functionality according to an embodiment of the disclosure;

FIG. 16 illustrates different UE implementation cases for AI/ML models according to an embodiment of the disclosure;

FIG. 17 illustrates different levels of LCM for AI/ML according to an embodiment of the disclosure;

FIG. 18 illustrates notational Model-ID based LCM according to an embodiment of the disclosure;

FIG. 19 illustrates procedure for notational Model-ID based LCM according to an embodiment of the disclosure;

FIG. 20 illustrates a case for AI/ML processing unit (APU) management according to an embodiment of the disclosure;

FIG. 21 illustrates a case for AI/ML processing timeline management according to an embodiment of the disclosure;

FIG. 22 illustrates a relationship of conditions and additional conditions for configuration for AI/ML operations according to an embodiment of the disclosure; and

FIG. 23 illustrates a procedure to align the UE and network in terms of supported conditions and additional conditions for AI/ML operations according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4^{th} generation (4G) communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHZ, to enable robust coverage and mobility support. Aspects of the disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

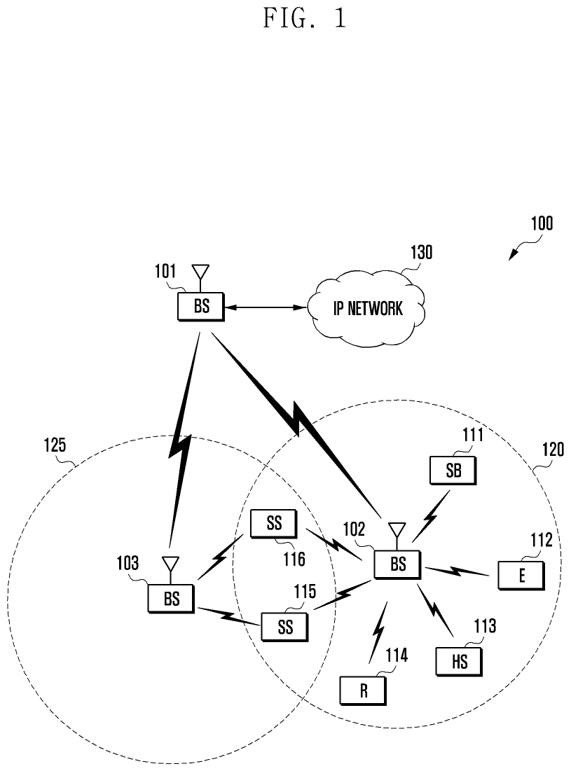

FIG. 1 illustrates an example wireless network according to an embodiment of the disclosure. The embodiment of the wireless network shown in FIG. 1 is for illustration only. Other embodiments of the wireless network can be used without departing from the scope of this disclosure.

Referring to FIG. 1, a wireless network 100 includes gNodeB (gNB) 101, gNB 102, and gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc.

The gNB 102 provides wireless broadband access to the IP network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the IP network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), long-term evolution advanced (LTE-A), worldwide interoperability for microwave access (WiMAX), or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of gNB 101, gNB 102, and gNB 103 include two-dimensional (2D) antenna arrays as described in embodiments of the disclosure. In some embodiments, one or more of gNB 101, gNB 102, and gNB 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the IP network 130. Similarly, each gNB 102-103 can communicate directly with the IP network 130 and provide UEs with direct wireless broadband access to the IP network 130. Further, the gNB 101, 102, and/or 103 can provide access to other or additional external networks, such as external telephone networks or other types of data networks.

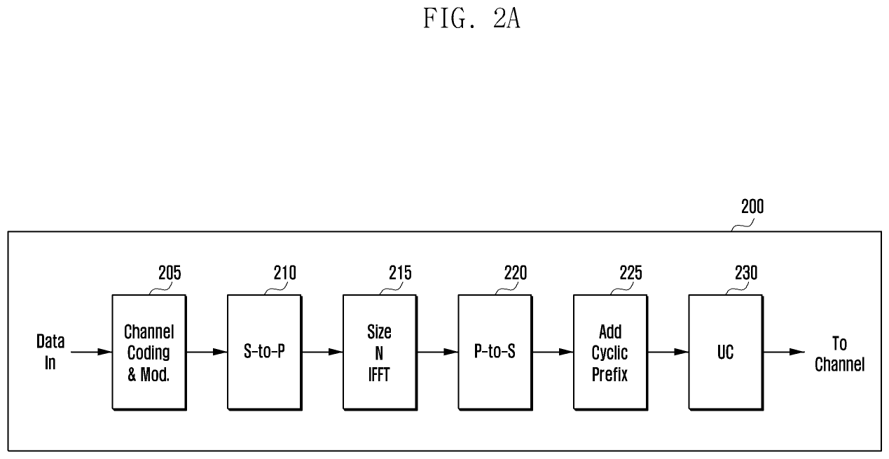

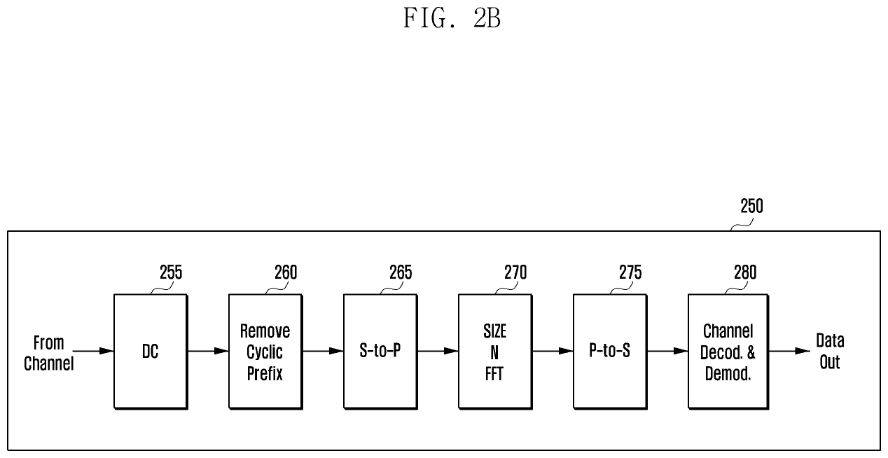

FIGS. 2A and 2B illustrate example wireless transmit and receive paths according to various embodiments of the disclosure.

Referring to FIGS. 2A and 2B, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the size N FFT block 270 and the size N IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

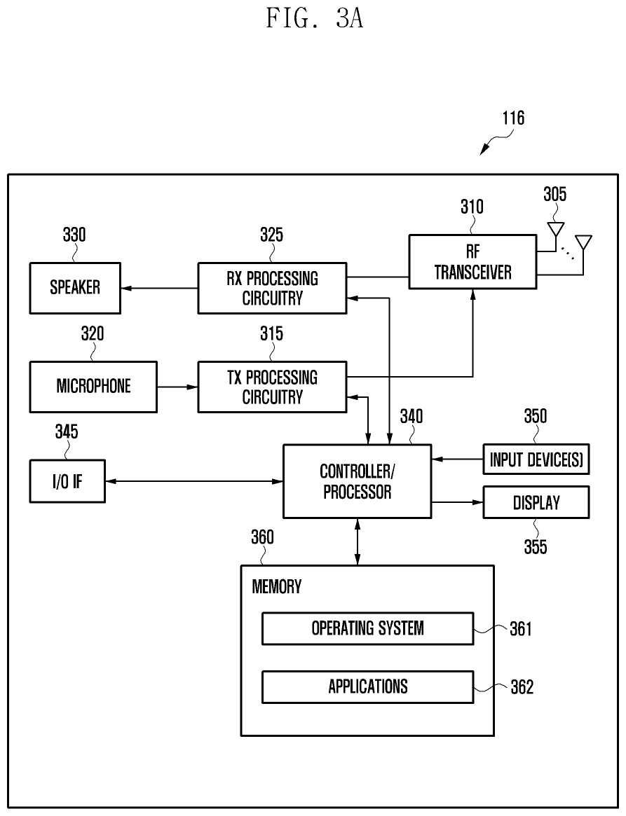

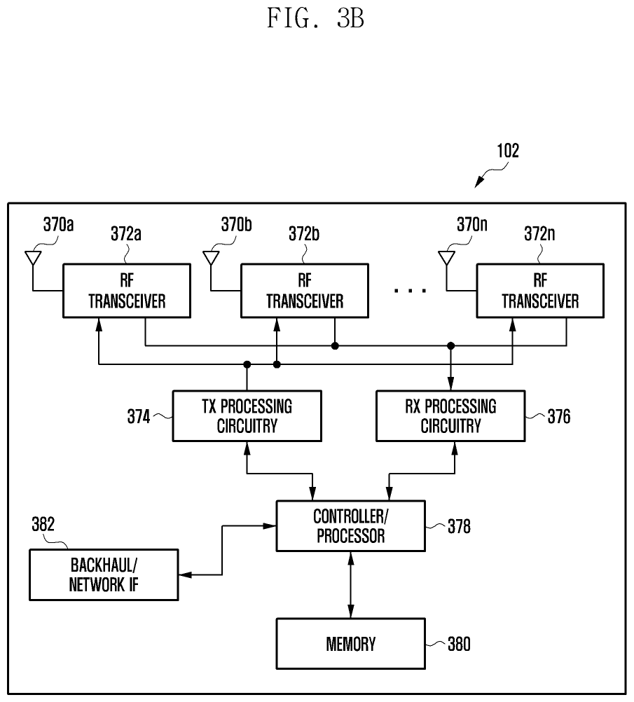

FIG. 3A illustrates an example UE 116 according to an embodiment of the disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface 345, input device(s) (e.g., a keypad) 350, a display 355, and memory 360. The memory 360 includes a basic operating system (OS) program 361 and one or more applications 362.

The RF transceiver 310 receives, from the antenna 305, an incoming RF signal transmitted by an gNB of the wireless network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the disclosure as described in embodiments of the disclosure. The main processor 340 can move data into or out of the memory 360 as required by an executing process. In some embodiments, the main processor 340 is configured to execute the one or more applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main processor 340.

The main processor 340 is also coupled to the input device(s) 350 and the display 355. The operator of the UE 116 can use the input device(s) 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to an embodiment of the disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

Referring to FIG. 3B, gNB 102 includes multiple antennas 370a and 370b-370n, multiple RF transceivers 372a and 372b-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The backhaul or network interface 382 can support communications over any suitable wired or wireless connection(s). For example, when the gNB 102 is implemented as part of a cellular communication system (such as one supporting 5G, LTE, or LTE-A), the backhaul or network interface 382 can allow the gNB 102 to communicate with other gNBs over a wired or wireless backhaul connection. When the gNB 102 is implemented as an access point, the backhaul or network interface 382 can allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of a gNB 102, various changes may be made to FIG. 3B. For example, the gNB 102 can include any number of each component shown in FIG. 3B. As a particular example, an access point can include a number of backhaul or network interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Multiple input multiple output (MIMO) system wherein a BS and/or a UE is equipped with multiple antennas has been widely employed in wireless systems for its advantages in terms of spatial multiplexing, diversity gain and array gain.

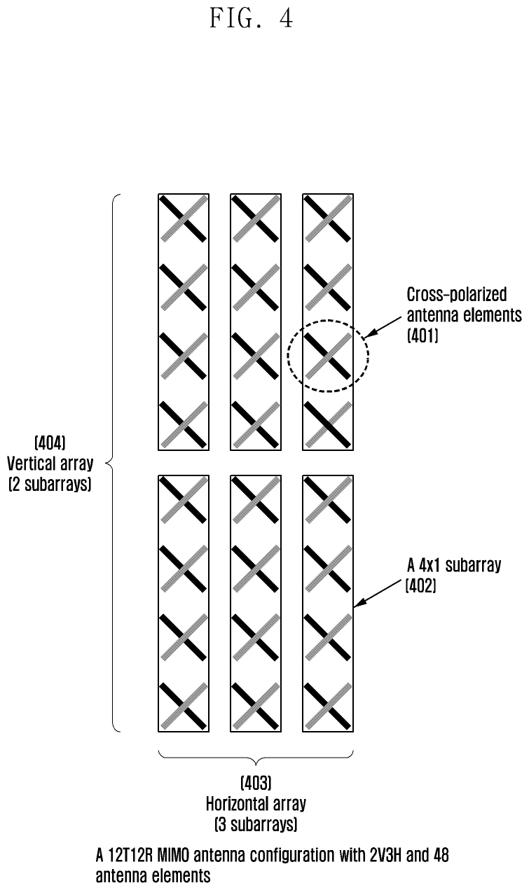

FIG. 4 illustrates an example of MIMO antenna configuration with 24 antenna elements according to an embodiment of the disclosure.

Referring to FIG. 4, 4 cross-polarized 401 antenna elements form a 4×1 subarray 402. 12 subarrays form a 2V3H MIMO antennas configuration consisting 2 and 3 subarrays in vertical and horizontal dimensions, respectively (e.g., a vertical array including 2 subarrays 404 and a horizontal array including 3 subarrays 403). Although FIG. 4 illustrates one example of MIMO antenna configuration, the disclosure can be applied to various such configurations.

In MIMO systems, the channel state information (CSI) is required at the base station (BS) so that a signal from the BS is received at the UE with maximum possible received power and minimum possible interference. The acquisition of CSI at the BS can be via a measurement at the BS from an UL reference signal or via a measurement and feedback by the UE from a DL reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

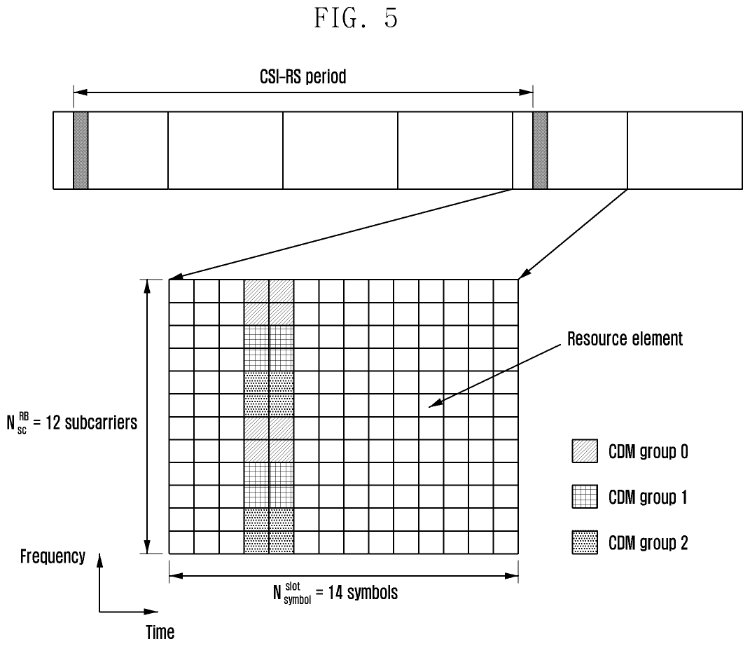

In some embodiments, a UE may receive a configuration signaling from a BS for a CSI-RS that can be used for channel measurement. An example of such configuration is illustrated in FIG. 5.

FIG. 5 illustrates a layout for channel state information reference signal (CSI-RS) resource mapping in an orthogonal frequency division multiple access (OFDM) time-frequency grid according to an embodiment of the disclosure.

Referring to FIG. 5, 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G NR standards, three time-domain CSI-RS resources configurations, namely: periodic, semi-persistent and aperiodic are possible. In the figure, an illustrative example of periodic configuration is given with a period of 4 slots.

Moreover a UE can be configured to measure a CSI feedback with a CSI report configuration. A CSI report configuration can be periodic, semi-persistent or aperiodic manner.

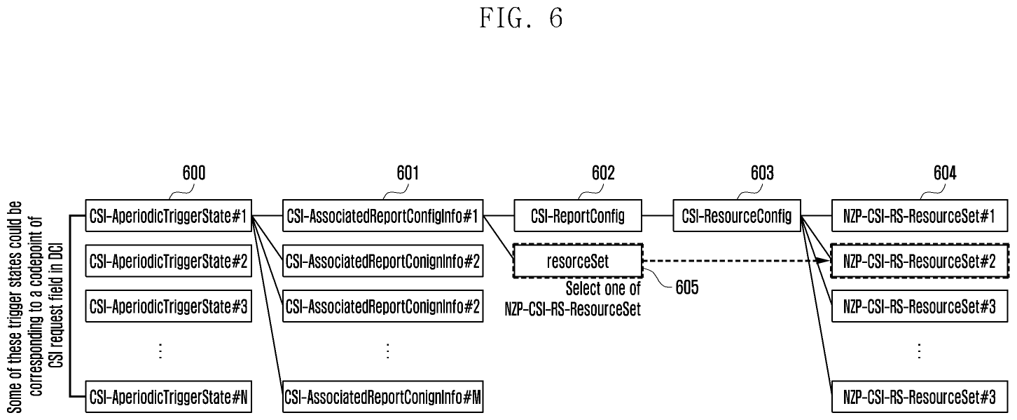

FIG. 6 depicts the CSI report configuration and CSI measurement configurations that is supported in 5G NR system according to an embodiment of the disclosure. A CSI report configuration 602 can be linked to a CSI resource configuration 603. The CSI resource configuration 602 may contain one or more CSI resource sets 604 for channel measurement (CMR) or inference measurement (IMR).

In the case of periodic (P) and semi-persistent (SP) CSI report setting, the CSI resource configuration contains a single CSI resource set. In case of aperiodic (AP) CSI report, a UE can be configured with multiple CSI report triggering states 600. A downlink control information (DCI) may include CSI request which indicates one of the configured triggering states. Moreover, the DCI with CSI request may also contain CSI report configuration information 601 and a resource set selection field 605 to select one of the one or more CSI resources sets 604.

Moreover, a CSI report can be configured with one of the CSI reporting quantities. This may include CSI resource indicator (CRI), the rank indicator (RI), precoding matrix indicator (PMI), channel quality indicator (CQI), layer indicator (LI), SINR, RSRP. In 5G NR, various CSI reporting quantiles are adopted. In particular, an RRC parameter reportQuantity set to either ‘none’, ‘cri-RI-PMI-CQI’, ‘cri-RI-il’, ‘cri-RI-il-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’ or ‘ssb-Index-SINR-Index’.

The CSI reporting can be used for transmission beam management (BM), specifically, in higher frequency bands, e.g., in frequency range 2 (FR2). In this case, the gNB may configure the UE to report one of the following quantities including, ‘cri-RSRP’, ‘cri-SINR’, ‘ssb-Index-RSRP’, ‘ssb-Index-SINR’, ‘cri-RSRP-Index’, ‘ssb-Index-RSRP-Index’, ‘cri-SINR-Index’ or ‘ssb-Index-SINR-Index’.

For a yet another purpose, the CSI report can be used for the downlink transmission CSI including ‘cri-RI-PMI-CQI’, ‘cri-RI-il’, ‘cri-RI-il-CQI’, ‘cri-RI-CQI’.

Recently, data-driven algorithms, also known as artificial-intelligence or machine-learning (AI/ML), have gained considerable attentions. Main application areas include solving non-linear optimization problems that cannot be directly solved by convention solutions. Use cases that have recently been highlighted include CSI compression, CSI prediction, beam prediction, positioning, channel estimation and interpolation, MU-MIMO scheduling, etc.

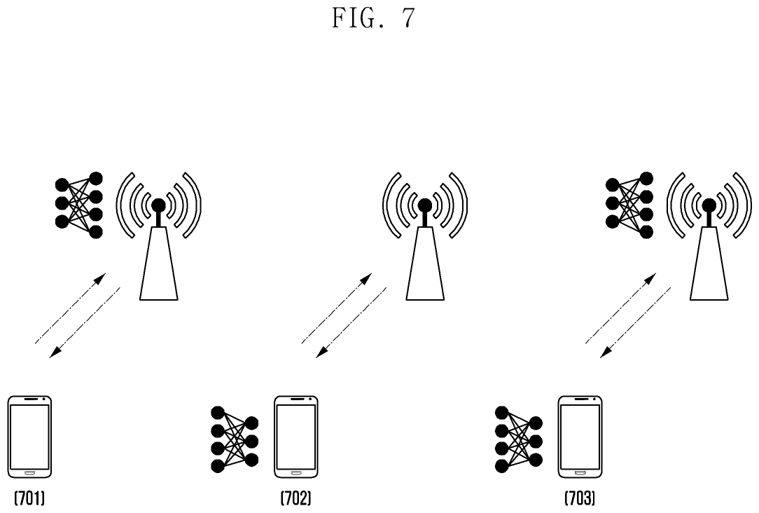

FIG. 7 illustrates single-sided and two-sided models according to an embodiment of the disclosure. In this disclosure, any data-driven algorithm and its parts are referred as AI/ML model.

Referring to FIG. 7, such AI/ML model can be located at the network, as indicated at 701, at the UE, as indicated at 702, or at both UE and network, as indicated at 703. An AI/ML model may require to be trained with a training dataset before it is used for inference (to produce a set of prediction output from set of inputs). When the AI/ML model inference is performed in one node, i.e., UE or network node, such model is referred as single-sided model or, in particular, UE-sided model or network-sided model. When the inference is jointly made at two nodes, i.e., the first part of the inference at UE and the second part at the network, the AI/ML model is said to be two-sided model.

One use case of artificial intelligence (AI) is AI/ML based CSI feedback. In particular, an auto-encoder (AE), which is a two-sided model, consisting of an encoder part at the UE which generates the CSI feedback and a decoder at the gNB which reconstructs the CSI feedback. The main aim of an AE-based CSI feedback is to find the best representation of a channel state information in terms of feedback overhead. In another words, AE compresses the CSI to reduce the CSI feedback overhead.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the below various mechanisms for full channel matrices, i.e., full CSI, reporting are provided.

In the below detailed description of the disclosure, the terms “AI/ML model”, “model” “AI model” are used interchangeably to refer to a data-driven algorithm that takes a certain set of inputs and produces a certain set of outputs. An AI/ML model may require to be trained with a training dataset before it is used for inference (to produce a set of prediction output from set of inputs).

The AI/ML model can be neural network (NN)-based which is composed of a large number of interconnected neurons. The neurons can be described by parameters which may consist of weights and biases. The interconnection between neural networks may have structure. A typical form of structure is assortments of neurons into multiple layers. If the number of layers in AI/ML model is relatively large, the model can be referred as deep neural network (DNN). Then, the layers could be interconnected with dense or sparse connections.

The AI/ML model can take various backbone structures, e.g., dense neural networks (DNN) convolutional neural network (CNN), Long-short term memory (LSTM), transformer (TF), etc.

An AI/ML model can be scenario-specific or configuration-specific, i.e., it provides the desired performance only in a set of scenarios or set of configurations. These models are typically trained by a dataset collected from a certain set of scenarios and configurations. For example, an AI/ML CSI compression model may perform as desired only when it is applied to a set of CSI ports (antenna ports) configuration or CSI payload size configurations. In another case, an AI/ML CSI compression model may work only under certain set of scenarios, e.g., UE speed.

In some embodiments, the UE or network may have to keep multiple scenario/configurations specific AI/ML models for different sets of scenarios or configurations. Thus, when a certain set of configurations is applied or a certain scenarios is detected, the UE or network may select the appropriate model, i.e., model selection.

In some embodiments, the UE or network may have to activate the appropriate AI/ML model for inference. This activation process may require the UE or network to load the model to the processing unit, e.g., central processing unit (CPU), graphical processing unit (GPU), neural processing unit (NPU), etc.

In some embodiments, the UE or network may have to deactivate an AI/ML model. This deactivation process may include unloading the model from the processing unit (freeing up the processing unit), e.g., central processing unit (CPU), graphical processing unit (GPU), and neural processing unit (NPU).

In some embodiments, the UE or network may have to switch through AI/ML models depending on the scenarios and configurations. The switching process may include deactivation, selection and activation of AI/ML models.

In some embodiments, the UE or network may have to update an AI/ML models based dataset for a set of scenarios and configurations. The model update process may include at least updating the model parameters based on training dataset.

In some embodiments, the UE or network may have to collect training dataset for a given scenarios or configurations. The training data collected can then be applied to train a new model or update an existing one.

In some embodiments, the UE or network may have to monitor the performance of AI/ML model. The model monitoring process may include comparison of the output from AI/ML model to the ground truth. In some cases, one node makes measurement of the ground truth and one node makes AI/ML model inference. In such cases, it may be necessary to exchange monitoring dataset, e.g., ground truth, AI/ML model inference output, from one node to the other.

In some embodiments, one node, e.g., network node, UE, may train a model and transfer to the other node. The model can be compiled for execution before or after the model transfer. This may be beneficial as it allows to train the model in the environment it is going to be used (for inference).

The process of managing the different aspects mentioned above, including: data collection, model training, model selection, model activation, model inference, model deactivation, model switching, model updating, model monitoring, etc., can be referred as model life cycle management (LCM).

In some embodiments a node can give assistance or control the LCM of a model in another node. As a typical example, the network may assist/control a model in the UE side for UE-side or UE part of two-sided model.

In some consideration, the network may provide the LCM assistance to the UE by being specific to a particular model. Thus, the network may be required to identify the model in UE side unambiguously. For this purpose a model ID can be used. This type of model LCM assistance can be termed as model-ID based LCM.

The model ID for model-ID based LCM can be associated to an implementation of AI/ML model, e.g., certain model structure, model parameter values and model quantization, etc. Thus, model ID can identify certain implementation of an AI/ML model unambiguously. If a model identified in this manner are deployed in more than one UEs, the same set of outputs is expected from the deployed models if the same set of inputs are fed to them.

The assignment of a model ID to a model for Model-ID-based LCM can be performed in a model registration process.

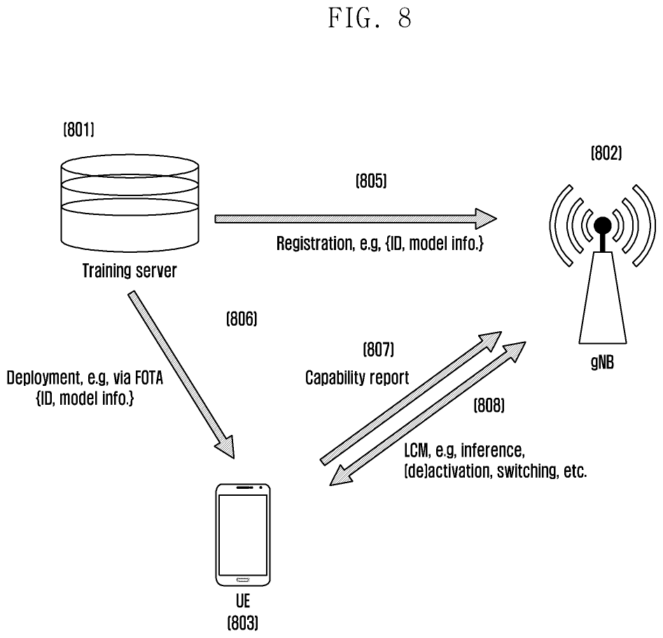

FIG. 8 illustrates Model-ID based LCM according to an embodiment of the disclosure.

In one case, referring to FIG. 8, a model can be trained, tested at training server 801. It then gets registered, as indicated at 805, to a registration server. The registration process may include assignment of model ID and association of meta-information. The meta-information may include all or subset of the following, model input information, model output information, model application scope (applicable scenarios, configurations), model size, model computational complexity information, model inference delay information, etc. The model can be deployed, as indicated at 806, to a UE 803. The UE 803 may report, as indicated at 807, its capability by indicating the supported AI/ML models via indication of model ID. A network 802 then provides LCM assistance, as indicated at 808, to the UE 803 based on the reported models UE supports.

One practical limitation of model-ID based LCM is scalability. Model-ID based LCM may require assignment of a model ID for each possible implementations of AI/ML model. However, as the number of implementations is expected to be very large, such implementation dependent model identification is not scalable.

Another issue with model-ID-based LCM is its flexibility with respect to model update. In a model-ID based LCM, model update whether major or minor, may require model re-registration and model-ID reassignment. This process may incur delay between the model update and use (inference). Thus, it may be less flexible to update a model.

In some considerations, the network may provide LCM assistance to the UE based on the identified AI/ML functionalities it supports.

In one consideration, an AI/ML functionality may mean some or all of the following: model purpose (use case), model input configuration, model output configuration, model scope, model application scenarios, etc. Then the network may provide LCM assistance to the UE based on the AI/ML functionalities the UE the supports. In the forthcoming description of the disclosure, such approaches are referred to as functionality-based LCM.

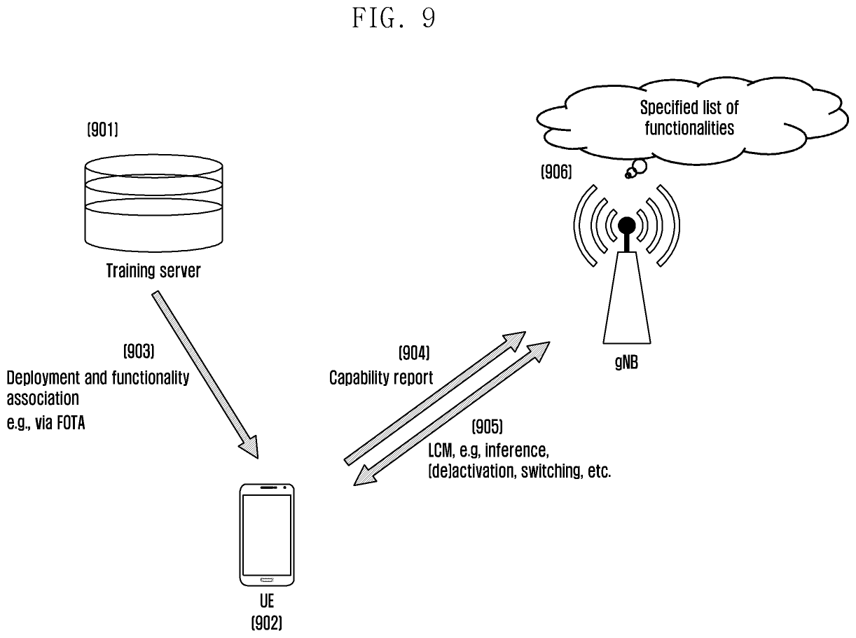

One procedure of functionality-based LCM is depicted in FIG. 9.

FIG. 9 illustrates functionality based LCM according to an embodiment of the disclosure.

A model can be trained and tested at a model training server 901. The model can then be deployed to a UE 902 with description on associated functionalities, as indicated at 903. The associated functionalities could be from a set of specified AI/ML functionalities. In this case, UE capability signaling, as indicated at 904, informs the network which AI/ML functionalities the UE supports. Then, a network 906 may provide the LCM assistance, as indicated at 905, to the UE based on the reported AI/ML functionalities.

In the following, we provide various approaches on how to report UE's capability on its supported functionalities.

Functionality-based LCM.

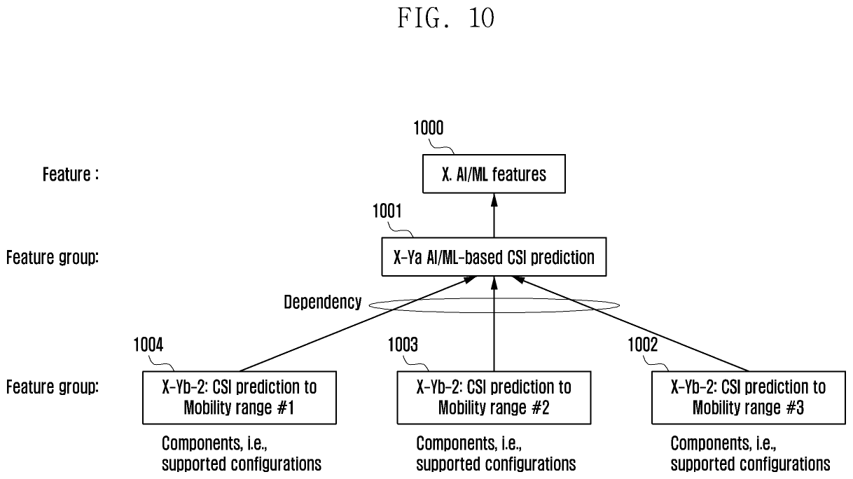

FIG. 10 illustrates hierarchical representation of AI/ML features and functionalities according to an embodiment of the disclosure.

Referring to FIG. 10, in this approach, AI/ML feature is specified. The AI/ML feature may include feature groups 1000 that define AI/ML features for certain use cases. One case is AI/ML-based CSI prediction as a UE supported feature group 1001. Sub-feature groups 1002, 1003, and 1004 can be specified which defines the application scenarios a certain AI/ML feature group could be applied to. Sub-feature groups includes CSI prediction for different mobility ranges (UE speeds), e.g., mobility range #1 (10-30 kilometers per hour (kmphr)), mobility range #2 (30-60) kmphr, mobility range #3 (60-120) kmphr.

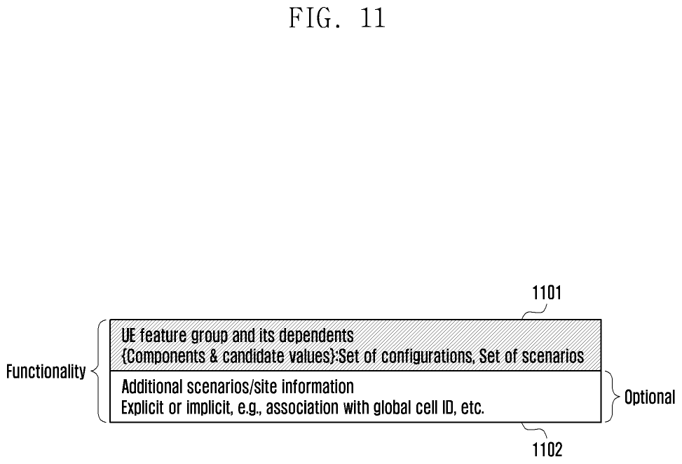

FIG. 11 illustrates possible definition of a functionality according to an embodiment of the disclosure.

Referring to FIG. 11, in some cases, the AI/ML model may be trained by dataset collected from a certain environment, e.g., cell, site, zone, TRP coverage area. In this case, it may be useful if a UE's capability report indicates additional scenario/site/environment related information. In this case, the functionality can be defined as UE feature group, associated components and its dependents 1101 with additional optional information for applicable scenarios and site information 1102.

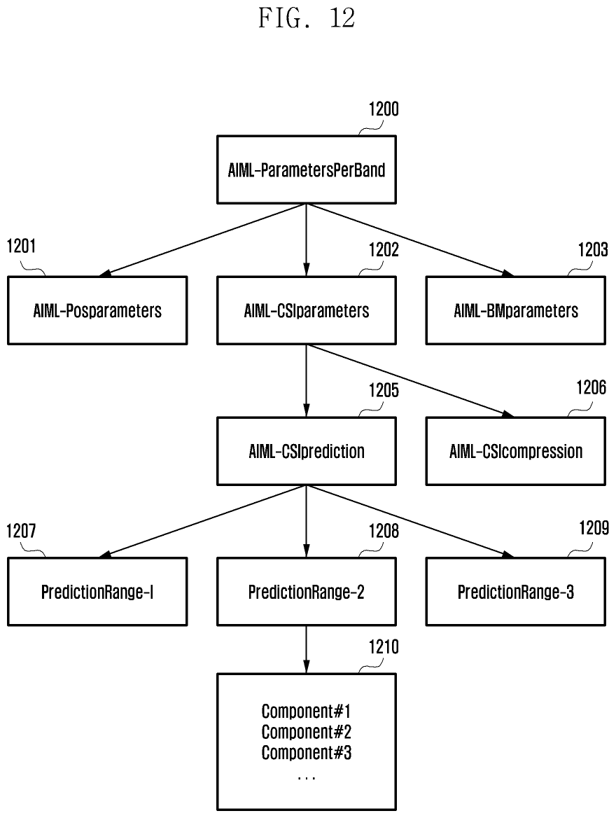

In an embodiment of the disclosure, the UE reports its capability by higher layer signaling as a combination of feature groups, supported component values and additional scenarios and site information. One higher layer signaling structure is provided in FIG. 12.

FIG. 12 illustrates hierarchical representation of higher layer signaling for functionality-based LCM according to an embodiment of the disclosure.

A higher layer parameter, e.g., ‘AI/ML-ParametersPerBand’ 1200, provides the supported AI/ML features a UE reports. Features groups could be ‘AI/ML-Posparameters’ 1201, ‘AI/ML-CSIparameters’ 1202, ‘AI/ML-BMparameters’ 1203, etc., for indication of support for AI/ML based positioning, CSI feedback, and beam management, respectively.

An AI/ML feature may further be associated with dependent feature groups. For example, AI/ML based CSI compression and AI/ML-based CSI prediction can be defined as separate feature groups. Thus, UE may indicate the supported feature groups separately. Higher layer parameter for this includes, ‘AI/ML-CSIprediction’ 1205, ‘AI/ML-CSIcompression’ 1206.

In an embodiment of the disclosure, the UE can report the supported AI/ML feature for a given sets of scenarios. The association between AI/ML feature and sets of scenarios can be hard configured in the specification. In this case, it is necessary to define sub-feature groups in a higher layer parameter that indicates the association of AI/ML feature and associated scenario. One such parameter will be ‘PredictionRange-1’ 1207, ‘PredictionRange-2’ 1208, ‘PredictionRange-3’ 1209. As aforementioned, these parameters may represent different scenarios, i.e., UE speed ranges.

In a yet another embodiment of the disclosure, the UE can report the supported AI/ML feature for a given sets of scenarios as a component of another feature groups. Here, the specification may provide candidate values of the scenario-indicating component. One specific example is under CSI-prediction feature group a component for speedRange can have candidate values {‘Range1’, ‘Range2’, ‘Range3’}.

The association between AI/ML feature and sets of scenarios can be hard configured in the specification. In this case, it is necessary to define sub-feature groups in a higher layer parameter that indicates the association of AI/ML feature and associated scenario. One such parameter will be ‘PredictionRange-1’ 1207, ‘PredictionRange-2’ 1208, ‘PredictionRange-3’ 1209. As aforementioned, these parameters may represent different scenarios, i.e., UE speed ranges.

The UE then subsequently reports the supported components 1210 and candidate values for AI/ML features. These components may include configuration information or scenario information supported by the AI/ML models. An example, is the supported CSI measurement RS configurations for AI/ML as one of the components.

In the following, some of the above higher layer parameters configurations is provided as example.

TABLE 1

AI/ML-ParametersPerBand ::= SEQUENCE {
AI/ML-CSIparameters SEQUENCE {
}
AI/ML-BMparameters SEQUENCE {
}
AI/ML-Posparameters SEQUENCE {
}
....

TABLE 2
AI/ML-CSIparameters ::= SEQUENCE {
AI/ML-CSIprediction SEQUENCE {
PredictionRangeI SEQUENCE {
supportedCSI-RS-ResourceList SEQUENCE (SIZE (1.. maxNrofCSI-RS-
Resources)) OF SupportedCSI-RS-Resource,
supportedReportingCodebook ENUMERATED {Type1, Type2,
Type2-PS, Type2-r16, Type2-PS-r16, AIType1, AIType2},
supportedCSI-RS-ResourceListForMonitoring SEQUENCE (SIZE (1..
maxNrofCSI-RS-ResourcesForMonitoring)) OF SupportedCSI-RS-
ResourceForMonitoring,
SupportForSiteSpecific Enumerated{supported}
...
}
PredictionRange2 SEQUENCE {
...
},
PredictionRange2 SEQUENCE {
...
},
AI/ML-CSIcompression SEQUENCE {
PredictionRange-I SEQUENCE {
supportedCSI-RS-ResourceList SEQUENCE (SIZE (1.. maxNrofCSI-RS-
Resources)) OF SupportedCSI-RS-Resource,
supportedReportingCodebook ENUMERATED {Type1, Type2,
Type2-PS, Type2-r16, Type2-PS-r16, AIType1, AIType2},
supportedCSI-RS-ResourceListForMonitoring SEQUENCE (SIZE (1..
maxNrofCSI-RS-ResourcesForMonitoring)) OF SupportedCSI-RS-
ResourceForMonitoring,
...
}
PredictionRange-2 SEQUENCE {
...
},
PredictionRange-3 SEQUENCE {
...
},

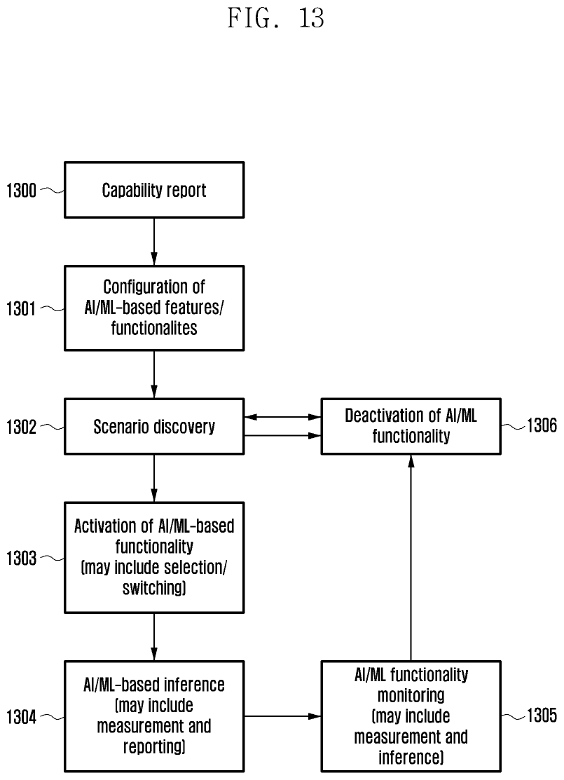

An embodiment of the disclosure, life-cycle of an AI/ML functionality is depicted in FIG. 13.

FIG. 13 illustrates a procedure for functionality-based LCM according to an embodiment of the disclosure.

A UE first reports its capability via higher layer signaling, at operation 1300. The aforementioned methods and higher layer structure can be utilized for such capability signaling. The UE then gets configured by the network with appropriate AI/ML-based features and functionalities according to the reported functionalities in UE's capability report.

In some embodiments of the disclosure, the configuration in operation 1301 may correspond to periodic AI/ML inference which may include periodic measurement and reporting. In this case, the AI/ML functionality configuration and activation can be considered to be performed at the same time. Thus, for periodic inference, the UE may interpret the AI/ML feature/functionality configuration as an activation of AI/ML feature/functionality.

In some embodiments of the disclosure, the configuration in operation 1301 may correspond to semi-persistent and aperiodic AI/ML inference which may include semi-persistent and aperiodic measurement and reporting. In this case, the AI/ML functionality configuration and activation can be considered to be performed at separate times.

In some embodiments of the disclosure, scenario discovery operation 1302 may be performed before the activation of AI/ML feature/functionality. The network can configure the appropriate measurement and reporting to enable such scenario discovery. Based on the received configuration information, the UE may measure and report quantities that may help the network to discover/estimate the scenario.

One example is the configuration, by network, of tracking reference signal (TRS) for measurement and reporting of (time/frequency/Doppler domain) correlation information reporting by the UE. Based on such reports, the network may implicitly estimate the UE speed range and configure the appropriate AI/ML functionality for CSI prediction, e.g., from {‘Range1’, ‘Range2’, ‘Range3’}.

Then, in yet another embodiment of the disclosure, the network activates AI/ML functionality at the UE. Such activation can be performed via explicitly by explicit activation signaling or implicitly.

In yet another embodiment of the disclosure, the network activates AI/ML functionality in operation 1303 at the UE explicitly by an MAC-CE or DCI. Upon reception of such activation signaling, the UE may get the AI/ML functionality for inference. One operation that can be performed by the UE is to fetch the AI/ML model from its internal storage to the temporary memory (cache memory) of processing unit, e.g., CPU, GPU, NPU, etc. Such activation information thus helps the UE to perform inference with shorter processing delay upon reception of a request for inference from the network.

In yet another embodiment of the disclosure, the network activates AI/ML functionality in operation 1303 at the UE implicitly by associating the AI/ML functionality with measurement and reporting configuration. In this case, a high layer parameter can be used AI/ML functionality with measurement and reporting configurations.

An example for such implicit activation is provided below. Under CSI reporting configuration, a higher layer parameter ‘associatedFunctionality’ can indicate to which AI/ML feature/functionality/scenario the CSI report configuration is associated with. Thus, when the network activates/triggers CSI report with such ‘associatedFunctionality’ field, the UE activates the appropriate AI/ML model.

TABLE 3

csiReportConfig#1{
. . . ..
associatedFuctionality CSI-ForMobilityRange1
measurmentConfig
codebookConfig. . . .
. . . .
}
}

TABLE 4

csiReportConfig#2{
. . . ..
associatedFuctionality CSI-ForMobilityRange2
measurmentConfig
codebookConfig. . . .
. . . .
}

Moreover, based on the disclosed implicit method, the network can switch from one AI/ML functionality to the another AI/ML functionality by activating/triggering CSI report which is associated with one AI/ML functionality to another AI/ML functionality. The UE then subsequently, if necessary, deactivates, in operation 1306, and activates, in operation 1303, the corresponding AI/ML models.

Then, upon the reception of a request from the network for AI/ML based inference, the UE may perform AI/ML model inference, in operation 1304. In an embodiment of the disclosure, such request can be carried out via DCI or MAC-CE message which triggers/activates measurement and report based on measurement and report configuration that are associated with AI/ML functionality.

In a yet another embodiment of this disclosure, the gNB may configure the UE with measurement and report configurations for AI/ML functionality monitoring, in operation 1305.

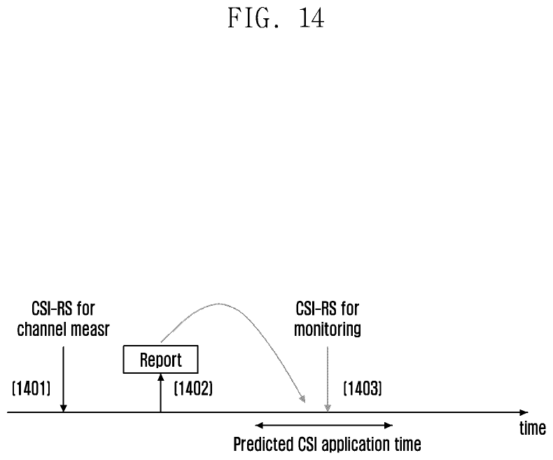

FIG. 14 illustrates a case for AI/ML functionality monitoring according to an embodiment of the disclosure.

Referring to FIG. 14, a method to achieve this to indicate measurement resources are for monitoring purpose via higher layer signaling. Higher layer parameter ‘resourcesForMonitoring CSI-ResourceConfigId’ is provided in the below. Upon reception of such configuration with higher layer parameter to configure CSI measurement resources 1401 for monitoring purpose, the UE measures the resources and perform performance monitoring of its model wherein the model corresponds to the AI/ML functionality associated with the configured report, e.g., ‘associatedFuctionality CSI-ForMobilityRange1’. Thus such configuration provides association and the CSI inference corresponding report 1402 and measurement for monitoring purpose 1403.

TABLE 5
csiReportConfig {
. . . ..
associatedFuctionality CSI-ForMobilityRange1
reourcesForChannelMeasurement CSI-ResourceConfigId, OPTIONAL
resourcesForMonitoring CSI-ResourceConfigId, OPTIONAL
. . . . }

In a yet another embodiment of this disclosure, the gNB may configure the UE with measurement and report configurations for training data collection for AI/ML functionality. A method to achieve this to indicate measurement resources are for data collection purpose via higher layer signaling. Higher layer parameter ‘resourcesForDataCollection CSI-ResourceConfigId’. Upon reception of such configuration with higher layer parameter to configure CSI measurement resources for data collection purpose, the UE measures the resources and report the collected data by tagging the associated AI/ML functionality indicated by higher layer parameter associatedFuctionality CSI-ForMobilityRange1′.

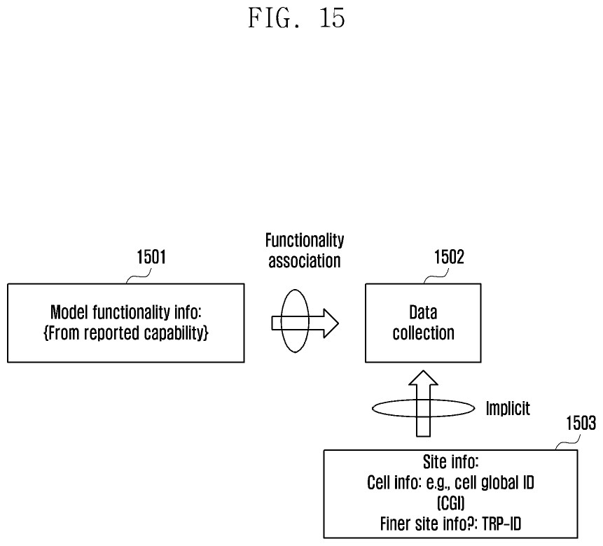

FIG. 15 illustrates relationship between data collection and functionality according to an embodiment of the disclosure.

Referring to FIG. 15, the gNB may configure the UE with measurement and report configurations for training data collection 1502 for AI/ML functionality. Such configuration may instruct the UE to report collected data by associating it with AI/ML functionality 1501 and/or site information 1503.

In the above embodiments what the network is aware of is the AI/ML functionalities supported by the UE. In other words, the actual AI/ML models deployed at the UE are transparent to the network. This approach has advantages in terms of preserving UE's privacy and implementation protection.

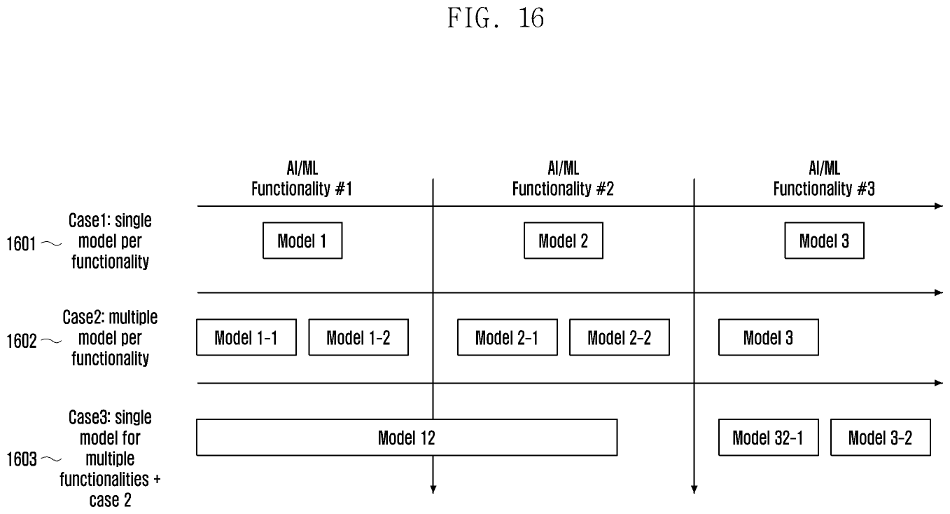

Cases for different UE implementations are provided in FIG. 16.

FIG. 16 illustrates different UE implementation cases for AI/ML models according to an embodiment of the disclosure.

Referring to FIG. 16, in Case1 1601, a UE implements a single model per functionality. On the other hand, in Case2 1602, a UE implements one or more models per functionality. Moreover, in Case3 1603, encompasses Case2 and the case that the UE uses a single model for multiple functionalities.

In the above functionality-based LCM, the network may not differentiate the 3 cases in FIG. 16. In some cases, however, it may be advantageous if the network does differentiate the three cases. As an example, if the network is aware of fact the UE reports the same model for functionality #1 and functionality #2, the UE may assume additional activation/deactivation delay may not be necessary to switch from functionality #1 to functionality #2.

Functionality-model association-based LCM (Notational Model-ID based LCM).

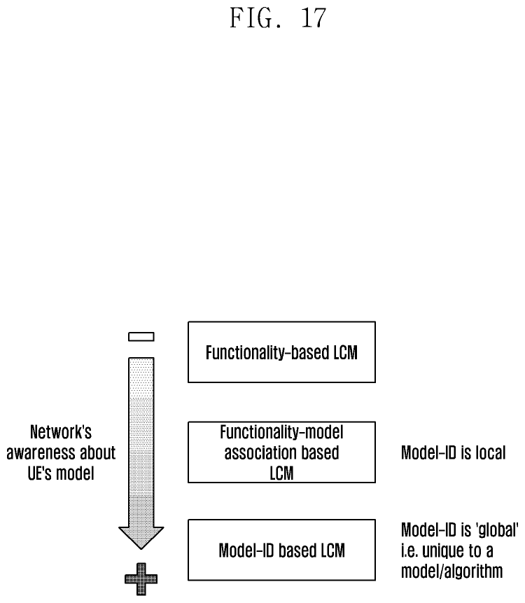

FIG. 17 illustrates different levels of LCM for AI/ML according to an embodiment of the disclosure.

Referring to FIG. 17, an LCM framework which allows the network to perform model-level LCM without being specific to actual AI/ML model implemented at the UE side. In the disclosed method, AI/ML models are identified by local model ID which is only valid after networks configurations as opposed to the global model IDs needed for model-ID based LCM. Thus, any model update the UE side does not require a registration process, as indicated at 805 of FIG. 8. Note the global model ID indicated at 805 requires to be assigned before UE's capability report and networks configuration of AI/ML based operations.

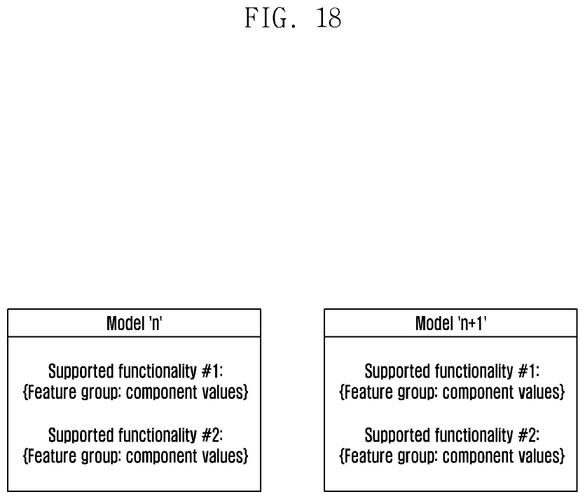

In an embodiment of this disclosure, the UE may report its capability by indicating the supported nominal/logical/notational AI/ML models in its capability signaling. A structure of such capability reporting is provided in FIG. 18.

FIG. 18 illustrates notational Model-ID based LCM according to an embodiment of the disclosure.

Referring to FIG. 18, as an embodiment, a UE may report the supported number of notational models (N) per feature group. Then for each model n=1, 2, . . . . N, the UE may report the supported functionalities. As an example for Model ‘n’ in FIG. 18, the UE reports the supported functionality #1 and functionality #2 by indicating them through the associated feature group and component values (configurations and scenarios).

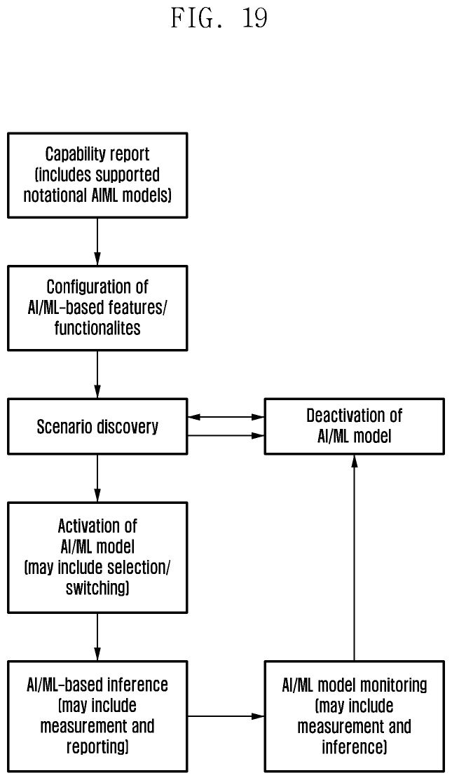

The process for functionality-model association (Notational model-ID based LCM) is provided in FIG. 19.

FIG. 19 illustrates procedure for notational Model-ID based LCM according to an embodiment of the disclosure.

Referring to FIG. 19, a UE reports its capability report by including information related to the supported AI/ML models. At this point the UE and the network may make agreement on the assignment of a notational model ID. One method is to assign model ID based on the ordinal position of the reported model in UE's capability report among models for certain feature group, i.e., first model in the report is assigned ID ‘1’ or ‘0’ and n-th model is assigned model ID ‘n-1’ or ‘n’.

TABLE 6
AI/ML-CSIparameters ::= SEQUENCE {
AI/ML-CSIprediction SEQUENCE {
supportedModelList SEQUENCE (SIZE (1..
maxNrofModelPerFeature)OF AI/ML-ModelforCSIPrediction,
...
}
AI/ML-ModelforCSIPrediction SEQUENCE {
Model-ID CHOICE(1.. maxNrofModelPerFeature) Optional
SupportedFunctionalities SEQUENCE (SIZE (1..
maxNrofSupportedFunctionalities)) OF SupportedAI/ML-functionalities,
...}
SupportedAI/ML-functionalities SEQUENCE {
Component1 ENUMERATED( candidateValues)
Component2 ENUMERATED( candidateValues2)

In an embodiment of the disclosure, a method is introduced for the UE to configure a notational model ID to its reported models. To achieve this, the UE reports the models with a ‘model-ID’ field assigned with a value. Higher layer signaling is provided above.

Upon the reception UE's capability report on the supported AI/ML models, the network then configures the AI/ML features. In an embodiment of the disclosure, a method to like measurement and reporting configurations with AI/ML model is provided. Here, the network can configure the UE with measurement and reporting configurations by indicating the associated AI/ML features and model ID by higher layer parameter. Higher layer signaling is provided below.

TABLE 7

csiReportConfig#1{
. . . ..
associatedFuctionality CSI-Prediction
associatedModel-ID Model-ID
measurmentConfig
codebookConfig. . . .
. . . .
}
}

In a yet another embodiment of this disclosure, the gNB may configure the UE with measurement and report configurations for AI/ML model monitoring. A method to achieve this to indicate measurement resources are for monitoring purpose via higher layer signaling. Higher layer parameter ‘resourcesForMonitoring CSI-ResourceConfigId’ is provided in the below. Upon reception of such configuration with higher layer parameter to configure CSI measurement resources for monitoring purpose, the UE measures the resources and perform performance monitoring of its model wherein the model corresponds to the AI/ML functionality associated with the configured report, e.g., ‘associatedModel Model ID. Thus such configuration provides association and the CSI inference corresponding report and measurement for monitoring purpose.

TABLE 8
csiReportConfig {
. . . ..
associatedFuctionality CSI-prediction
associatedModel Model-ID
reourcesForChannelMeasurement CSI-ResourceConfigId, OPTIONAL
resourcesForMonitoring CSI-ResourceConfigId, OPTIONAL
. . . . }

In a yet another embodiment of this disclosure, the gNB may configure the UE with measurement and report configurations for training data collection for nominal/logical/notational AI/ML model. A method to achieve this to indicate measurement resources are for data collection purpose via higher layer signaling. Higher layer parameter ‘resourcesForDataCollection CSI-ResourceConfigId’. Upon reception of such configuration with higher layer parameter to configure CSI measurement resources for data collection purpose, the UE measures the resources and report the collected data by tagging the associated AI/ML functionality indicated by higher layer parameter associatedModel Model-ID.

One advantage of Notational Model ID based LCM disclosed in the disclosure is it provide common understanding between the network and the UE on UE's budget on AI/ML processing resources and properly manage them. This helps the network not to overload the UE beyond its processing capability.

In an embodiment of the disclosure, a method to measure and report UE's computational capability for AI/ML operations is introduced. The AI/ML processing computational capability can be reported in terms of AI/ML processing units (APUs).

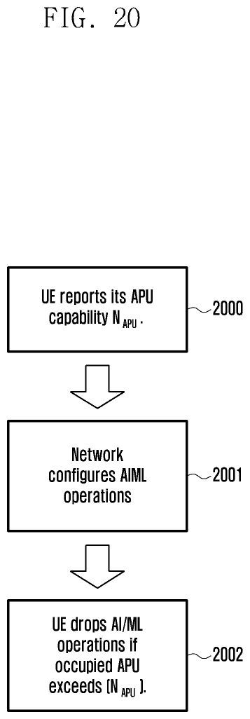

FIG. 20 illustrates a case for AI/ML processing unit (APU) management according to an embodiment of the disclosure.

Referring to FIG. 20, in an embodiment of the disclosure, the UE reports, in operation 2000, its computational capability as NAPU units. The APU requirement of each AI/ML operation, e.g., inference, monitoring, etc. can be defined in the specification per each AI/ML feature group. The network then considers the remaining APU budget of the UE while requesting AI/ML-based operations.

However, it may be beneficial for the network if it is allowed to configure the UE with AI/ML operation, in operation 2001, that may cause overloading, e.g., for efficiency purposes. In an embodiment of the disclosure, the UE drops, in operation 2002, the AI/ML operations, e.g., inference, monitoring, etc., if the occupied AI/ML processing units exceeds its reported capability (NAPU). The dropping could be based on the priority of AI/ML operations, the configuration order, etc.

In an embodiment of the disclosure, a method to align AI/ML processing timeline between a UE and network is introduced. It is essential for the network and UE have the common understanding on the minimum processing time required to achieve certain AI/ML functionalities/models.

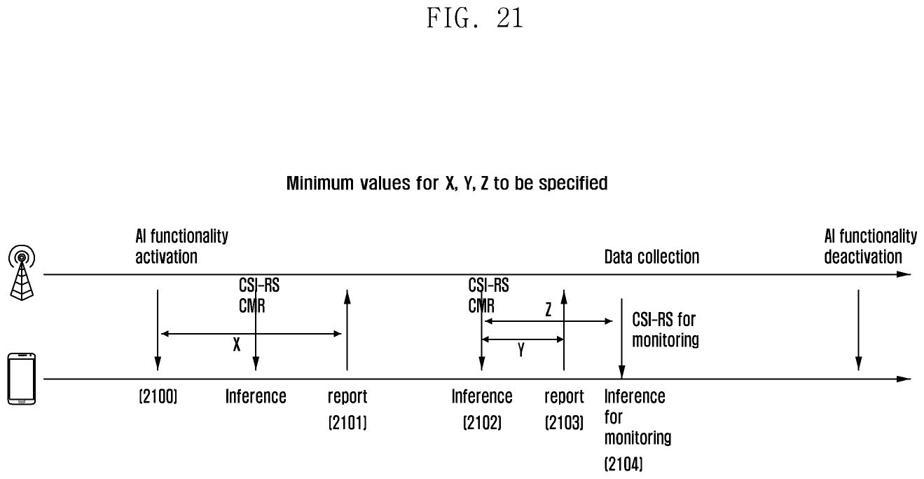

FIG. 21 illustrates a case for AI/ML processing timeline management according to an embodiment of the disclosure.

Referring to FIG. 21, in an embodiment of the disclosure, a method to set a minimum processing time required AI/ML model/functionality activation (X), as indicated at 2100 to 2101 is introduced. The UE is not expected to acknowledge AI/ML model/functionality activation request before X time units (symbols, ms, etc.) from the slot the AI/ML activation request is received.

In an embodiment of the disclosure, a method to set a minimum processing time required AI/ML model/functionality inference (Y), as indicated at 2102 to 2103 is introduced. The UE is not expected to report based on AI/ML inference request before Y time units (symbols, ms, etc.) from the slot the AI/ML inference request is received.

In an embodiment of the disclosure, a method to set a minimum processing time required AI/ML model/functionality monitoring (Z), as indicated at 2102 to 2104 is introduced. The UE is not expected to measure for AI/ML monitoring before Y time units (symbols, ms, etc.) from the slot the AI/ML inference request is received.

In an embodiment of the disclosure, the values of X, Y and Z are hard configured per AI/ML feature in the specification

In an embodiment of the disclosure, the values of X, Y and Z are reported as part of the UE's capability report per AI/ML feature.

Model identification from network and UE

In the following, a multitude of methods are disclosed in relation to model identification process initiated by the network to the UE and/or the model identification from UE to the network.

First, consider the following the implementation problem the model identification can resolve. As an example, there may be implementation dependency (compatibility issue) that may arise in UE-sided beam prediction. When the beam prediction is done by an AI/ML model at the UE, i.e., UE-side AI/ML model, the Set-B (measurement set) and Set-A (prediction set) can be configured to UE as a set (group) of CSI-RS resources. In general, the mapping between the CSI-RS resources in Set-A and Set-B to the physical transmission beams is up to gNB's implementation. As an example, the beam characteristics, including pointing angles, beam width, etc., for the beams corresponding to CSI-RS resources in Set-B can be different from one gNB to the other. Moreover, even in one gNB or cell, the pointing angles of such beam might vary in time or across TRPs. AI/ML model for beam prediction must be trained with the same mapping between the physical beam characteristics to measurement resources (CSI-RS) during the training and inference stages. Therefore, a mechanism to secure consistency in relation to the Network-side setting, i.e., ‘network-side additional information’, during the training and inference stage is highly desired.

In order to alleviate the aforementioned problem, the disclosure introduces the following methods.

In one aspect of the disclosure, the network may configure the UE with parameters that explicitly carry the related configuration information. These parameters can indicate the required conditions for the AI/ML model inference, monitoring, data collection or other AI/ML model operations. A condition for AI/ML based CSI-prediction is number of CSI-RS ports. Another condition for AI/ML-based beam prediction is configuration on the set beams for measurement and set of candidate beams for prediction.

As another aspect of this disclosure, the network may also indicate or configure the UE with implicit parameters to carry information on additional conditions for AI/ML model inference, monitoring, data collection or other AI/ML model operations. The indicators for the additional conditions may implicitly indicate the network-side or UE-side additional conditions. A network-side additional condition for AI/ML based CSI-prediction is the transmission-reception point (TRP) the CSI-RS resource for measurement is transmitted from. Another network-side additional condition for AI/ML-based beam prediction is the mapping between measurement and prediction sets to the physical transmission beam.

One way to acquire consistency on the assumptions for training and inference is based on network's indication (via a form of an ID) for the network-side additional conditions, i.e., network-side settings. If the same ID is mapped to the same network-side setting (additional condition) during data collection for model training and model inference, the compatibility/consistency issue can be mitigated. The UE-side vendor can use this ID and other information such as cell global ID or other location related information to categorize the collected dataset for training. The collected dataset can be used to train AI/ML models (including site-specific models). Later in the inference stage, the model is developed and deployed to the UE, if the same indication is provided to the UE, it may be used for the selection of a model in a transparent manner. One may consider such indication on network-side additional conditions as dataset ID or model identification via over-the-air signaling.

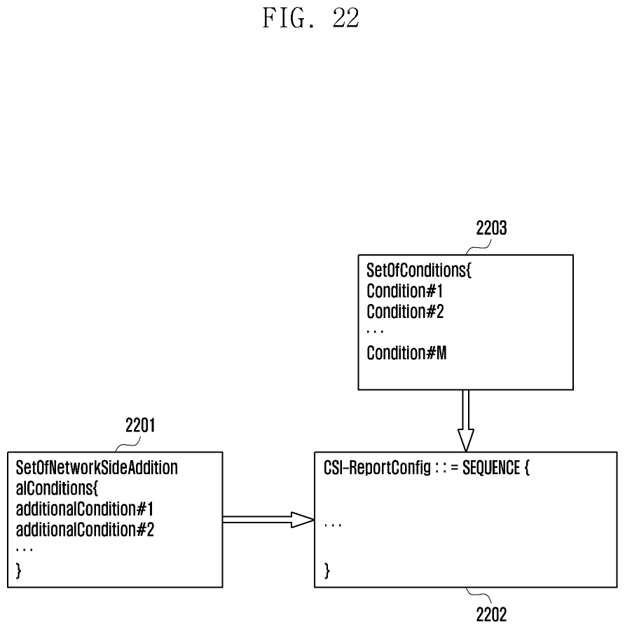

FIG. 22 illustrates a relationship of conditions and additional conditions for configuration for AI/ML operations according to an embodiment of the disclosure.

Referring to FIG. 22, a relationship of conditions 2203 and additional conditions 2201 for configuration for AI/ML operations including at least inference, monitoring or data collection is illustrated. In FIG. 22, a CSI-reportConfig 2202 is considered as a configuration for AI/ML-based operation.

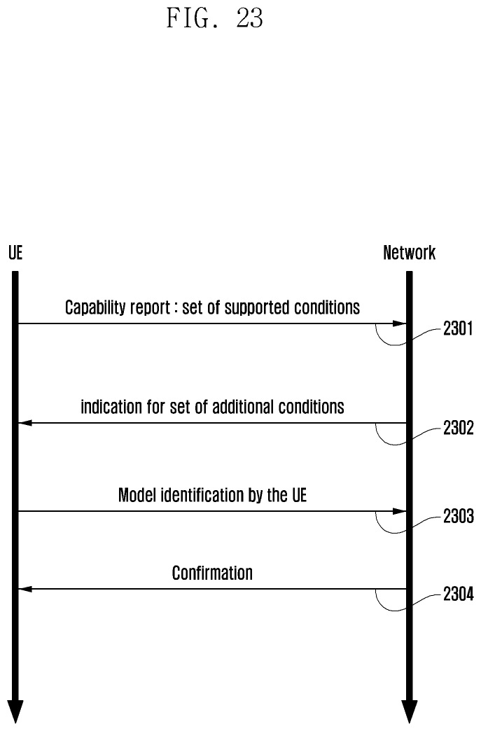

FIG. 23 illustrates a procedure to align the UE and network in terms of supported conditions and additional conditions for AI/ML operations according to an embodiment of the disclosure.

While the procedure is shown as a series of steps, various steps could overlap, occur in parallel, occur in a different order, or occur multiple times. First, the UE may report the supported conditions, in operation 2301. The capability report may carry the information on supported AI/ML functionalities. Thus, operation 2301 can be in the form of AI/ML features, feature groups and supported components and corresponding candidate values. The Network then may indicate the set of additional conditions, in operation 2302, that implicitly indicate the network-side additional conditions. This step can be considered as model-identification from the network's perspective. The network may indicate for network-side additional conditions in relation to conditions reported by the UE's capability report. As an additional operation, in operation 2303, the UE may report/indicate to the network its nominal/notational/logical AI/ML models. The UE may indicate the nominal/notational/logical AI/ML models by associating them with supported functionalities, conditions and additional conditions. Operation 2303 can be considered as model identification from the UE's perspective. The Network may acknowledge or confirm the UE's model identification, in operation 2304. The Network then may configure the configuration for AI/ML operations including inference, monitoring, data collection, etc.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
transmitting, to a base station, capability information indicating a set of artificial intelligence (AI)/machine learning (ML) functionalities;
receiving, from the base station, configuration information associated with an AI/ML inference, wherein the configuration information indicates at least one of a measurement configuration or a reporting configuration;
receiving, from the base station, information to indicate activation of an AI/ML functionality; and
performing an AI/ML based operation based on the configuration information.

2. The method of claim 1,
wherein the measurement configuration includes at least one of resources for AI/ML performance monitoring or resources for AI/ML data collection, and
wherein the AI/ML based operation comprises at least one of AI/ML performance monitoring based on the resources for AI/ML performance monitoring or AI/ML data collection based on the resources for AI/ML data collection.

3. The method of claim 1,
wherein the capability information indicates a set of notational model identifications (IDs) associated with the set of AI/ML functionalities,
wherein the configuration information indicates a notational model ID from the set of notational model IDs, and
wherein the notational model ID is associated with an AI/ML functionality from the set of AI/ML functionalities.

4. The method of claim 1, further comprising:
identifying at least one of a minimum processing time required for an AI/ML functionality activation, a minimum processing time required for an AI/ML functionality inference, or a minimum processing time required for an AI/ML functionality monitoring.

5. The method of claim 1, further comprising:
transmitting, to the base station, a set of conditions associated with the AI/ML based operation; and
receiving, from the base station, a set of additional conditions associated with the AI/ML based operation.

6. A user equipment (UE) in a communication system, the UE comprising:
a transceiver; and
at least one processor configured to:
transmit, to a base station, capability information indicating a set of artificial intelligence (AI)/machine learning (ML) functionalities,
receive, from the base station, configuration information associated with an AI/ML inference, wherein the configuration information indicates at least one of a measurement configuration or a reporting configuration,
receive, from the base station, information to indicate activation of an AI/ML functionality, and
perform an AI/ML based operation based on the configuration information.

7. The UE of claim 6,
wherein the measurement configuration includes at least one of resources for AI/ML performance monitoring or resources for AI/ML data collection, and
wherein the AI/ML based operation comprises at least one of AI/ML performance monitoring based on the resources for AI/ML performance monitoring or AI/ML data collection based on the resources for AI/ML data collection.

8. The UE of claim 6,
wherein the capability information indicates a set of notational model identifications (IDs) associated with the set of AI/ML functionalities,
wherein the configuration information indicates a notational model ID from the set of notational model IDs, and
wherein the notational model ID is associated with an AI/ML functionality from the set of AI/ML functionalities.

9. The UE of claim 6, wherein the at least one processor is further configured to:
identify at least one of a minimum processing time required for an AI/ML functionality activation, a minimum processing time required for an AI/ML functionality inference, or a minimum processing time required for an AI/ML functionality monitoring.

10. The UE of claim 6, wherein the at least one processor is further configured to:
transmit, to the base station, a set of conditions associated with the AI/ML based operation, and
receive, from the base station, a set of additional conditions associated with the AI/ML based operation.

11. A method performed by a base station in a communication system, the method comprising:
receiving, from a user equipment (UE), capability information indicating a set of artificial intelligence (AI)/machine learning (ML) functionalities;
transmitting, to the UE, configuration information associated with an AI/ML inference, wherein the configuration information indicates at least one of a measurement configuration or a reporting configuration; and
transmitting, to the UE, information to indicate activation of an AI/ML functionality for an AI/ML based operation.

12. The method of claim 11,
wherein the measurement configuration includes at least one of resources for AI/ML performance monitoring or resources for AI/ML data collection, and
wherein the AI/ML based operation comprises at least one of AI/ML performance monitoring based on the resources for AI/ML performance monitoring or AI/ML data collection based on the resources for AI/ML data collection.

13. The method of claim 11,
wherein the capability information indicates a set of notational model identifications (IDs) associated with the set of AI/ML functionalities,
wherein the configuration information indicates a notational model ID from the set of notational model IDs, and
wherein the notational model ID is associated with an AI/ML functionality from the set of AI/ML functionalities.

14. The method of claim 11, further comprising:
identifying at least one of a minimum processing time required for an AI/ML functionality activation, a minimum processing time required for an AI/ML functionality inference, or a minimum processing time required for an AI/ML functionality monitoring.

15. The method of claim 11, further comprising:
receiving, from the UE, a set of conditions associated with the AI/ML based operation; and
transmitting, to the UE, a set of additional conditions associated with the AI/ML based operation.

16. A base station in a communication system, the base station comprising:
a transceiver; and
at least one processor configured to:
receive, from a user equipment (UE), capability information indicating a set of artificial intelligence (AI)/machine learning (ML) functionalities,
transmit, to the UE, configuration information associated with an AI/ML inference, wherein the configuration information indicates at least one of a measurement configuration or a reporting configuration, and
transmit, to the UE, information to indicate activation of an AI/ML functionality for an AI/ML based operation.

17. The base station of claim 16,
wherein the measurement configuration includes at least one of resources for AI/ML performance monitoring or resources for AI/ML data collection, and
wherein the AI/ML based operation comprises at least one of AI/ML performance monitoring based on the resources for AI/ML performance monitoring or AI/ML data collection based on the resources for AI/ML data collection.

18. The base station of claim 16,
wherein the capability information indicates a set of notational model identifications (IDs) associated with the set of AI/ML functionalities,
wherein the configuration information indicates a notational model ID from the set of notational model IDs, and
wherein the notational model ID is associated with an AI/ML functionality from the set of AI/ML functionalities.

19. The base station of claim 16, wherein the at least one processor is further configured to:
identify at least one of a minimum processing time required for an AI/ML functionality activation, a minimum processing time required for an AI/ML functionality inference, or a minimum processing time required for an AI/ML functionality monitoring.

20. The base station of claim 16, wherein the at least one processor is further configured to:
receive, from the UE, a set of conditions associated with the AI/ML based operation; and
transmit, to the UE, a set of additional conditions associated with the AI/ML based operation.
